(19) United States
(12) Patent Application Publication
(10) Pub. No.: US 2010/0182295 A1
(43) Pub. Date: Jul. 22, 2010

(54) LCD DRIVING CIRCUIT AND DRIVING METHOD THEREOF

(76) Inventor: Ping-Po CHEN, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/356,340

(22) Filed: Jan. 20, 2009

(51) Int. Cl. G09G 5/00

(52) U.S. Cl. 345/208

(57) ABSTRACT

A LCD driving circuit is provided herein. The LCD driving circuit includes a data processor for processing a plurality of data signals to generate a plurality of processed data signals to respectively drive a line of subpixels arranged on a LCD panel, a driving control module having a data sequence unit for receiving and arranging the processed data signal, and a switching control unit to generate a control signal and a plurality of driving signals corresponding with the control signal to drive a plurality of transistors, a source line driving circuit having a plurality of latching units to respectively store the processed data signal.

Moreover, a driving method for LCD is also disclosed herein.

### BACKGROUND

1. Field of Invention

The present invention relates to a circuit and method for a display, more particularly, to a circuit and method for driving a LCD panel.

2. Description of Related Art

For reducing the coupling effect and increasing the efficiency of data transmission, lines of subpixels of a LCD panel are respectively connected with transistors, data should be transmitted to subpixels in a certain sequence determined by the arrangement of the transistors and the subpixels. In order to transmit the data for the subpixels in appropriate timing, the data should be mapped before being transmitted, which is referred to as the data mapping, i.e., the data are arranged in a certain sequence. However, the process of data mapping requires sufficient storing space to process a large amount of data, such that a driving circuit can carry out the process without any complications.

Moreover, once the arrangement of the transistors and the subpixels is modified, masks for manufacturing the circuit should also be altered accordingly. However, the cost and labors for the alteration is considerably high.

Therefore, to save the cost and labor consumed, it is desired to provide a LCD driving circuit and driving method thereof.

### SUMMARY

Therefore, one aspect of the invention is to provide a LCD driving circuit to alleviate the processing loading for data mapping and decrease the number of masks for manufacturing the LCD driving circuit that need to be altered once an LCD panel driver is modified.

In a first embodiment of the invention, a LCD driving circuit provided includes a data processor for processing a plurality of data signals to generate a plurality of processed data signals to respectively drive a line of subpixels arranged on a LCD panel, a driving control module having a data sequence unit for receiving and arranging the processed data signal, and a switching control unit to generate a control signal and a plurality of driving signals corresponding with the control signal to drive a plurality of transistors, a source line driving circuit having a plurality of latching units to respectively store the processed data signal.

Furthermore, according to the first embodiment, the source line driving circuit also includes a multiplexer to multiplex the data signals stored in accordance with the control signal, a digital-to-analog converter to convert the multiplexed data signals from digital to analog, and an output buffer to buffer the converted data signals, wherein the transistors are respectively connected between the source line driving circuit and the subpixels.

One other hand, another aspect of the invention is to provide a driving method for a LCD panel to alleviate the processing loading for data mapping and decrease the number of masks for manufacturing the LCD driving circuit that need to be altered once a LCD panel is modified.

In a second embodiment of the invention, a driving method for LCD panel provided includes steps of providing a line of data signals to respectively drive the subpixels arranged on a LCD panel; generate a control signal; generate a plurality of driving signals corresponding with the control signal to turn on a plurality of switches; and respectively store the data signals.

Moreover, according to the second embedment, the driving method still includes the steps of multiplexing the data signals in accordance with the control signal, converting the multiplexed the data signals from digital to analog; and buffering the converted the data signals, wherein the switches permit the transmission of the buffered data signals.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 depicts a wiring diagram of an exemplary LTPS panel according to a first embodiment of this invention.

FIG. 2 depicts a schematic diagram of an exemplary LCD with a LCD driving circuit according to a first embodiment of the invention.

FIG. 3 depicts a partial functional diagram of an exemplary driving circuit shown in FIG. 2 according to a first embodiment of the invention.

FIG. 4 is a flow chart of an exemplary driving method for an LCD according to a second embodiment of this invention.

### DETAILED DESCRIPTION

Once the architecture of the LCD panel is modified, a plurality of masks for a variety of manufacturing process related to the LCD driver circuit must be altered accordingly. However, if the data mapping can be replaced in another way, the number of the optical masks that need to be altered may greatly be reduced.

Therefore, a LCD driving circuit provided in following embodiment is configured to process data signals, so as to sequentially drive lines of subpixels arranged on the LCD panel.

A LTPS (Low Temperature Poly-Silicon) panel is exemplarily implemented in the embodiments described below. However, in other embodiments of the invention, other type of flat display panels could also be implemented.

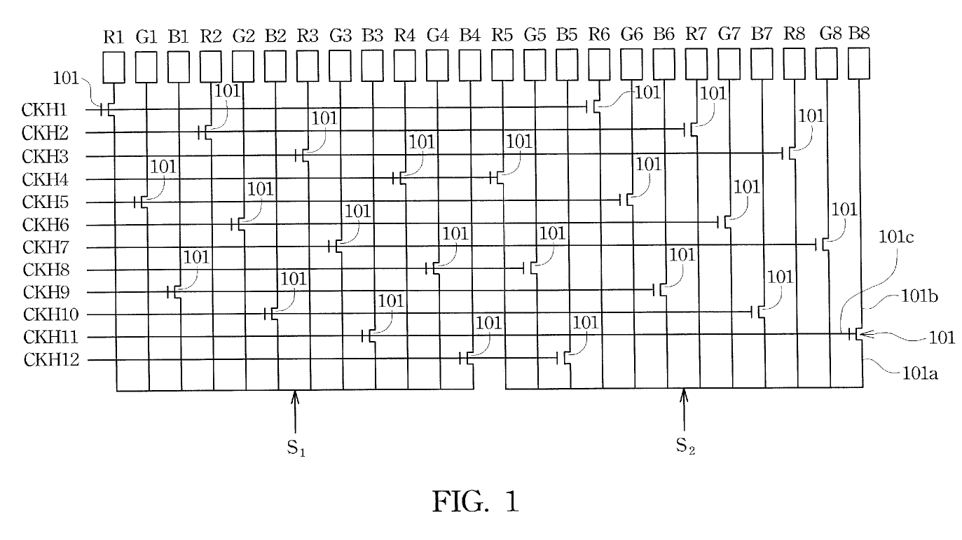

Refer to FIG. 1. FIG. 1 depicts a wiring diagram of an exemplary LTPS panel according to a first embodiment of this invention. In the embodiment, a first group of subpixels arranged in one line on the LTPS panel have red subpixels R1˜R4, green subpixels G1˜G4 and blue subpixels B1˜B4, and a second group of subpixels arranged in the line have red subpixels R5˜R8, green subpixels G5˜G8 and blue subpixels B5˜B8 as shown. Note that the color of the subpixels should not be limited to the three primary colors, however, the subpixels can display multi-primary colors, such as red, green, blue, yellow and cyan.

Take the first group of subpixels for example, transistors 101 respectively connected to the red subpixels R1˜R4, green subpixels G1˜G4 and blue subpixels B1˜B4 are also arranged on the LTPS panel 100. Each of the transistors 101 has an input terminal 101a and an output terminal 101b, and the input terminal 101a is configured to receive data to display image, and the output terminal 101b is connected to an electrode of the red subpixels R1˜R4, green subpixels G1˜G4 and blue subpixels B1˜B4. Furthermore, each of the transistors 101 also has a control terminal 101c to receive driving signals CKH1˜CKH12. The transistors 101 are switched according to a predetermined sequence with the driving signal CKH1˜CKH12.

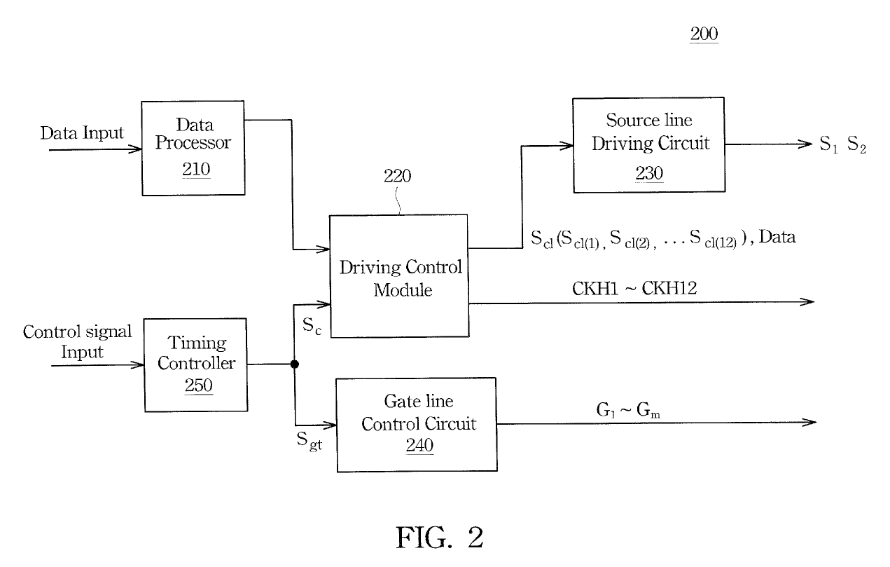

FIG. 2 depicts a schematic diagram of an exemplary LCD with a LCD driving circuit and a LTPS panel according to a first embodiment of the invention. The LCD driving circuit is configured to sequentially provide data to match with aforesaid sequence.

Referring to FIG. 1 and FIG. 2, in the embodiment, the LCD driving circuit 200 includes a data processor 210 configured to provide a plurality of data signals, e.g., red data RD1˜RD4, green data GD1˜GD4 and blue data BD1˜BD4 to respectively drive red subpixels R1˜R4, green subpixels G1˜G4 and blue subpixels B1˜B4 shown in FIG. 1. The LCD driving circuit 200 also has a driving control module 220 to generate a control signal S_{c1} that includes a series of signals S_{c1(1)}˜S_{c1(12)} and generate driving signals CKH1˜CKH12 corresponding with the control signal S_{c1} to drive transistors 101 respectively connected to the red subpixels R1˜R4, the green subpixels G1˜G4 and the blue subpixels B1˜B4. The control signals S_{c1(1)}˜S_{c1(12)} are pre-assigned to map with the driving signals CKH1˜CKH12 one for one. The driving control module 220 also transfer the data signals, red data RD1˜RD4, green data GD1˜GD4 and blue data BD1˜BD4, to a source line driving circuit 230. The source line driving circuit 230 to respectively store the red data RD1˜RD4, the green data GD1˜GD4 and the blue data BD1˜BD4 and then multiplex the data in accordance with the control signal S_{c1}. In addition, the transistors 101 are respectively connected between the source line driving circuit 230 and the red subpixels R1˜R4, the green subpixels G1˜G4 and the blue subpixels B1˜B4.

For example, the sequence of outputting the driving signals CKH1˜CKH12 in the first frame is CKH1→CKH2→CKH3→CKH4→CKH5→CKH6→CKH7→CKH8→CKH9→CKH10→CKH11→CKH12, such that the transistors are sequentially turned on and the subpixels should be driven accordingly, i.e., a data sequence S1 of the subpixels for the first frame is the subpixel R1, the subpixel R2, the subpixel R3, the subpixel R4, the subpixel G1, the subpixel G2, the subpixel G3, the subpixel G4, the subpixel B1, the subpixel B2, the subpixel B3, and the subpixel B4.

In a typical driving method, the data sequence S1 is processed first to form a data sequence that has mapped the driving signals CKH1˜CKH12. That is a mapping already data sequence, RD1, RD2, RD3, RD4, GD1, GD2, GD3, GD4, BD1, BD2, BD3, and BD4, is transferred to the source line driving circuit 230 to cooperate with the driving signals CKH1˜CKH12 and the control signal S_{c1}, S_{c1(1)}˜S_{c1(12),} to drive the LCD panel. The control signals S_{c1(1)}˜S_{c1(12)} are not pre-assigned to map with the driving signals CKH1˜CKH12 one for one The S_{c1(1)} controls the source line driving circuit 230 to output data RD1 to cooperate with the driving signal CKH1. The S_{c1(2)} controls the the source line driving circuit 230 to output data RD2 to cooperate with the driving signal CKH2. The S_{c1(3)} controls the the source line driving circuit 230 to output data RD3 to cooperate with the driving signal CKH3. The S_{c1(4)} controls the the source line driving circuit 230 to output data RD4 to cooperate with the driving signal CKH4. The S_{c1(5)} controls the the source line driving circuit 230 to output data GD1 to cooperate with the driving signal CKH5. The rest may be deduced by analogy. According to the typical method, these data, RD1, RD2, RD3, RD4, GD1, GD2, GD3, GD4, BD1, BD2, BD3, and BD4, have to be transfer to the driving control module 220 together. Then, the driving control module 220 can process these data to form a mapping already data sequence to transfer to the source line driving circuit 230. Therefore, in the typical method, the driving control module 220 needs to have a big storage space to store these data once.

However, in the claimed driving method, it is not necessary to process the data sequence to form a mapping already data first because the control signals S_{c1(1)}˜S_{c1(12)} are pre-assigned to map with the driving signals CKH1˜CKH12 one for one. That is the source line driving circuit 230 can receive the data sequences that have different order. For example, a data sequence, RD1, GD1, BD1, RD2, GD2, BD2, RD3, GD3, BD3, RD4, GD4 and BD4 is transferred to the source line driving circuit 230. The driving signals CKH1˜CKH12 correspond to the control signal S_{c1}, S_{c1(1)}˜S_{c1(12)}. The CKH1 correspond to the S_{c1(1)}. The CKH2 correspond to the S_{c1(4)}. The CKH3 correspond to the S_{c1(7)}. The CKH4 correspond to the S_{c1(10)}. The CKH5 correspond to the S_{c1(2)}. The S_{c1(1)} controls the source line driving circuit 230 to output data RD1 to cooperate with the driving signal CKH1. The S_{c1(4)} controls the source line driving circuit 230 to output data RD2 to cooperate with the driving signal CKH2. The S_{c1(7)} controls the source line driving circuit 230 to output data RD3 to cooperate with the driving signal CKH3. The S_{c1(10)} controls the source line driving circuit 230 to output data RD4 to cooperate with the driving signal CKH4. The S_{c1(2)} controls the source line driving circuit 230 to output data GD1 to cooperate with the driving signal CKH5. The rest may be deduced by analogy. Therefore, the data sequence S1 is still RD1, RD2, RD3, RD4, GD1, GD2, GD3, GD4, BD1, BD2, BD3, and BD4. In the claimed invention, it is not necessary to transfer a mapping already data to the source line driving circuit 230. The driving control module 220 needs not to process these data to form a mapping already data first. Therefore, the driving control module 220 needs not to receive these data once. In other words, the driving control module 220 needs not to have a big storage space to store these data. Accordingly, the claimed invention can have a minimal spare cell.

With the control signal S_{c1}, S_{c1(1)}˜S_{c1(12)} and corresponding driving signals CKH1˜CKH12, the data signals are transferred to the red subpixels R1˜R4, the green subpixels G1˜G4 and the blue subpixels B1˜B4 from the source line driving circuit 230 through the input terminal 101a of the transistors 101.

Because the control signals S_{c1(1)}˜S_{c1(12)} are pre-assigned to map with the driving signals CKH1˜CKH12 one for one, it is not necessary to provide a mapping already data signals to the source line driving circuit 230 in the claimed invention. Therefore, even though the arrangement of the transistors 101 on the LTPS panel 100 varies, different data sequence still can be transferred to the source line driving circuit 230 from the driving control module 220. The only change is that the corresponding relationship between the control signal S_{c1}, S_{c1(1)}˜S_{c1(12)} and the driving signals CKH1˜CKH12. Therefore, a reduced number of masks required in the process for manufacturing the LCD driving circuit 200, must be altered, e.g., masks implemented before backend masks do not have to be altered.

Moreover, the LCD driver circuit 200 also includes a gate line control signal 240 to provide a plurality of scan signals G₁˜Gₘ, one of the scan signals G₁˜Gₘ enables the red subpixels R1˜R4, green subpixels G1˜G4 and blue subpixels B1˜B4.

One of the scan signals G₁˜Gₘ turns on transistors (not shown) within the red subpixels R1˜R4, green subpixels G1˜G4 and blue subpixels B1˜B4, and the driving signals CKH1˜CKH12, the red data RD1˜RD4, the green data GD1˜GD4 and the blue data BD1˜BD4 would be transmitted to these subpixels synchronously.

The LCD driver circuit 200 of the embodiment could further include a timing controller 250 to control gate line control signal 240 operations with a signal S_{gt}, so as to adjust timings of the aforesaid data for each of frames displayed on the LTPS panel 100. In the embodiment, the timing controller 250 is also capable of controlling the driving control module 220 with a signal Sc.

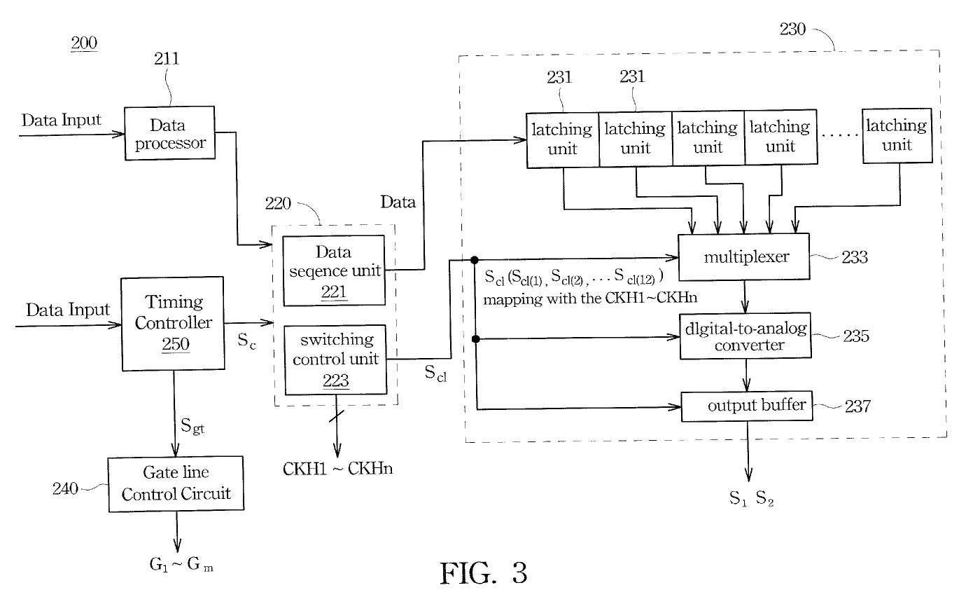

Refer to FIG. 3. FIG. 3 depicts a detailed functional diagram of an exemplary LCD driving circuit shown in FIG. 2 according to a first embodiment of the invention. According to this embodiment of the invention, the data processor 210 to pre-process the red data, the green data and the blue data.

Furthermore, the driving control module 220 includes a data sequence unit 221 to receive the processed data from the data processor 210 and generate a sequence data signals, and a switching control unit 223 to generate a control signal S_{c1} and a plurality of driving signals CKH1˜CKH12 corresponding with the control signal S_{c1}.

Still, the source line driving circuit 230 of the LCD driving circuit 200 includes latching units 231 to respectively store the red data RD1˜RD4, the green data GD1˜GD4 and the blue data BD1˜BD4, a multiplexer 233 for multiplexing these data from the latching units 231 in accordance with the control signal S_{c1}, a digital-to-analog converter 235 to convert the multiplexed red data, the green data and the blue data from digital to analog, and an output buffer 237, e.g., a unity-gain amplifier, is capable of buffering the converted red data RD1˜RD4, the green data GD1˜GD4 and the blue data BD1˜BD4. In the embodiment, the driving control module 220 is not only configured to control the to multiplexer 233 with the control signal S_{c1}, but also control operations of the digital-to-analog converter 235 and the output buffer 237.

With the control signal S_{c1} being pre-assigned to map with the driving signals CKH1˜CKH12 one for one, it is possible to synchronously operate the transistor 101 and transfer corresponding data signals to the subpixels R1˜B4. For example, a data sequence, RD1, GD1, BD1, RD2, GD2, BD2, RD3, GD3, BD3, RD4, GD4 and BD4 is arranged in the latching units 231. The driving signals CKH1˜CKH12 correspond to the control signal S_{c1}, S_{c1(1)}˜S_{c1(12)}. The CKH1 correspond to the S_{c1(1)}. The CKH2 correspond to the S_{c1(4)}. The CKH3 correspond to the S_{c1(7)}. The CKH4 correspond to the S_{c1(10)}. The CKH5 correspond to the S_{c1(2)}. The S_{c1(1)} controls the multiplexer 233 to output data RD1 to cooperate with the driving signal CKH1. The S_{c1(4)} controls the multiplexer 233 to output data RD2 to cooperate with the driving signal CKH2. The S_{c1(7)} controls multiplexer 233 to output data RD3 to cooperate with the driving signal CKH3. The S_{c1(10)} controls the multiplexer 233 to output data RD4 to cooperate with the driving signal CKH4. The S_{c1(2)} controls the multiplexer 233 to output data GD1 to cooperate with the driving signal CKH5. The rest may be deduced by analogy. Therefore, the data sequence S1 is RD1, RD2, RD3, RD4, GD1, GD2, GD3, GD4, BD1, BD2, BD3, and BD4.

Therefore, the number of masks for manufacturing the LCD driving circuit need to be altered is decreased once the LCD panel driver is modified.

The timing controller 250 adjusts the control signals S_{c1} and the driving signals CKH1˜CKH12 with the signal S_{c} to the driving control module 220. That is, the control signals S_{c1} and the driving signals CKH1˜CKH12 are generated in accordance with the signal S_{c}. The timing controller 250 controls the gate line control circuit 240. With such a configuration, the timing of the data required to display a frame is set precisely.

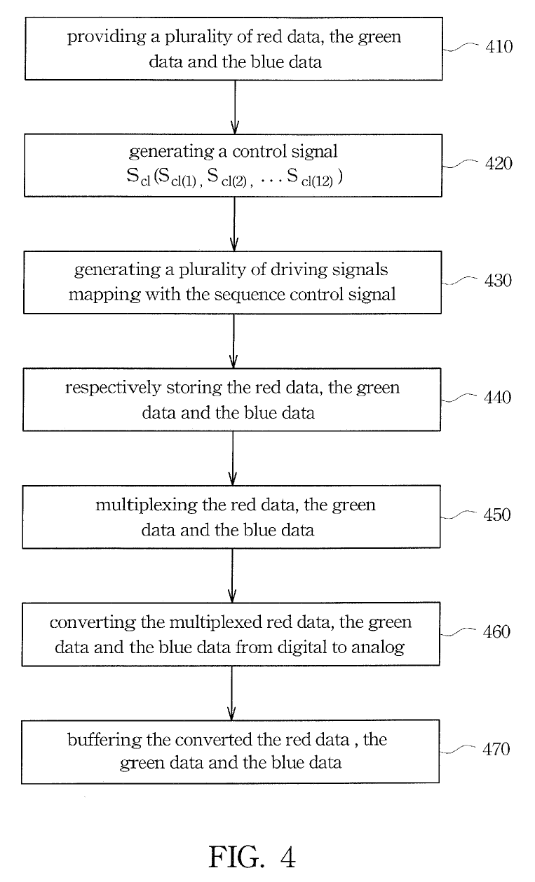

On the other hand, FIG. 4 depicts a flow chart of an exemplary driving method for an LCD according to a second embodiment of this invention a second embodiment of the invention. Refer to FIG. 3 and FIG. 4. FIG. 3 and FIG. 4 show the driving method includes the steps 410 to 470.

In Step 410, a plurality of red data RD1˜RD4, green data GD1˜GD4 and blue data BD1˜BD4 is provided to drive a plurality of red subpixels, green subpixels and blue subpixels arranged on a LCD panel;

In Step 420 a control signal S_{c1} is generated

Then, in Step 430 a plurality of driving signals CKH1˜CKH12 are generated. The control signals S_{c1(1)}˜S_{c1(12)} are pre-assigned to map with the driving signals CKH1˜CKH12 one for one. The driving signals CKH1˜CKH12 correspond with the control signal S_{c1} to turn on a plurality of switches, such as transistors. For example, RD1, GD1, BD1, RD2, GD2, BD2, RD3, GD3, BD3, RD4, GD4 and BD4 is arranged is provided to drive a plurality of red subpixels, green subpixels and blue subpixels arranged on a LCD panel. The pre-assigned mapping relationship between the driving signals CKH1˜CKH12 and the control signal S_{c1}, S_{c1(1)}˜S_{c1(12)} is that the CKH1 mapping to the S_{c1(1)} the CKH2 mapping to the S_{c1(4)}, the CKH3 mapping to the S_{c1(7)} the CKH4 mapping to the S_{c1(10)} the CKH5 mapping to the S_{c1(2)}, and so on.

In Step 440 the red data RD1˜RD4, the green data GD1˜GD4 and the blue data BD1˜BD4 are respectively stored after being received;

In Step 450 the red data RD1˜RD4, the green data GD1˜GD4 and the blue data BD1˜BD4 are multiplexed and stored in accordance with the control signal S_{c1}. For example, the S_{c1(1)} controls a multiplexer to output data RD1 to cooperate with the driving signal CKH1. The S_{c1(4)} controls a multiplexer to output data RD2 to cooperate with the driving signal CKH2. The S_{c1(7)} controls a multiplexer to output data RD3 to cooperate with the driving signal CKH3. The S_{c1(10)} controls a multiplexer to output data RD4 to cooperate with the driving signal CKH4. The S_{c1(2)} controls a multiplexer to output data GD1 to cooperate with the driving signal CKH5. The rest may be deduced by analogy.

In Step 460 the multiplexed red data RD1˜RD4, green data GD1˜GD4 and blue data BD1˜BD4 are converted from digital to analog; and

In Step 470 the converted red data RD1˜RD4, green data GD1˜GD4 and blue data BD1˜BD4 are buffered,

wherein, the switches control the transmission of the buffered red data RD1˜RD4, the green data GD1˜GD4 and the blue data BD1˜BD4.

The step 410 further includes a step to pre-process the red data RD1˜RD4, the green data GD1˜GD4 and the blue data BD1˜BD4, so as to generate the red data, green data and blue data. In the step 420 and step 430, the control signal S_{c1} and the driving signals CKH1˜CKH12 are generated in accordance with a control signal that is generated by a timing controller.

By implementing the control signal S_{c1} and driving signals CKH1˜CKH12, the switches, such as transistors, will synchronously be turned on with the red data RD1˜RD4, the green data GD1˜GD4 and the blue data BD1˜BD4 transmitted in sequence. Once a LCD panel driven is modified, numbers of masks for manufacturing the LCD driving circuit 200 need to be altered is decrease.

In the embodiment, a LTPS (Low Temperature Poly-Silicon) panel is driven with the driving method. Moreover, the driving method also includes a step of providing a plurality of scan signals G₁˜Gₘ, and one of the scan signals G₁˜Gₘ enables the red subpixels, green subpixels and blue subpixels. One of the scan signals G₁˜Gₘ is provided to turn on the transistors within the subpixels, such that one line of the subpixels arranged on the LTPS panel are sequentially turned on.

The driving method provided also includes steps of adjusting timings of the scan signals G₁˜Gₘ, such that timings of data for each of frames displayed on the LTPS panel are adjusted.

The driving method of the embodiment still includes a step of adjusting the control signal and the driving signals. That is, the control signals S_{c1} and the driving signals CKH1˜CKH12 are generated with the signal Sc.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A LCD driving circuit, comprising:
a data processor for processing a plurality of data signals to generate a plurality of processed data signals to respectively drive a line of subpixels arranged on a LCD panel;
a driving control module comprising:
a data sequence unit for receiving and transferring the processed data signals; and
a switching control unit to generate a plurality of control signals and a plurality of driving signals to drive a plurality of transistors, wherein the control signals are pre-assigned to map with the driving signals one for one; and
a source line driving circuit comprising:
a plurality of latching units to store the processed data signals sequentially;
a multiplexer controlled by the assigned control signal to multiplex the data signals corresponding to the assigned control signal;
a digital-to-analog converter to convert the multiplexed data signals from digital to analog; and
an output buffer to buffer the converted data signals,
wherein the transistors are respectively connected between the source line driving circuit and the subpixels.

2. The LCD driver circuit of claim 1, wherein each of the transistors has an input terminal and an output terminal, and the input terminal is connected to the source line driving circuit, and the output terminal is connected to one of the subpixels.

3. The LCD driver circuit of claim 2, wherein each of the transistors has a control terminal to receive the driving signal.

4. The LCD driver circuit of claim 1, wherein the output buffer is a unity-gain amplifier.

5. The LCD driver circuit of claim 1, wherein the LCD panel is a LTPS (Low Temperature Poly-Silicon) panel.

6. The LCD driver circuit of claim 1, further comprising:
a gate line control circuit to provide a plurality of scan signals, wherein one of the scan signals enables the subpixels.

7. A driving method for LCD panel, comprising:
providing a plurality of data signals to respectively drive a line of subpixels arranged on a LCD panel;
generating a plurality of control signals;
generating a plurality of driving signals to turn on a plurality of switches, wherein the control signals are pre-assigned to map with the driving signals one for one;
respectively storing the data signals;
multiplexing the data signals stored in accordance with the assigned control signal;
converting the multiplexed data signals from digital to analog; and
buffering the converted the data signals, wherein the switches permit the transmission of the buffered data signals.

8. The driving method of claim 7, wherein the step of providing the data signals comprises:
pre-processing the data signals.

9. The driving method of claim 7, wherein the LCD panel is a LTPS (Low Temperature Poly-Silicon) panel.

10. The driving method of claim 7, further comprising:
providing a plurality of scan signals, wherein one of the scan signals enables the subpixels.
